(19) United States
(12) Patent Application Publication
(10) Pub. No.: US 2016/0240133 A1
(43) Pub. Date: Aug. 18, 2016

(54) ELECTRO-OPTICAL UNIT, ELECTRO-OPTICAL DEVICE AND METHOD FOR OPERATING AN ELECTRO-OPTICAL DEVICE

(71) Applicant: NEDERLANDSE ORGANISATIE VOOR TOEGEPAST-NATUURWETENSCHAPPELIJK ONDERZOEK TNO, 's-Gravenhage (NL)

(72) Inventors: Gerwin Hermanus GELINCK, s' Gravenhage (NL); Albert Jos Jan Marie VAN BREEMEN, s' Gravenhage (NL)

(21) Appl. No.: 15/028,057

(22) PCT Filed: Oct. 10, 2014
(86) PCT No.: PCT/NL2014/050705

§ 371 Date: Apr. 8, 2016

(30) Foreign Application Priority Data
Oct. 10, 2013 (EP) 13188129.4

(51) Int. Cl. G09G 3/3208; G09G 5/10

(52) U.S. Cl. CPC G09G 3/3208; G09G 5/10; G09G 2310/0254; G09G 2330/028; G09G 2360/14

(57) ABSTRACT

An electro-unit (1) is provided comprising a photodiode (2), a light-emitting diode (3) and a programmable resistive memory element (4). The electro-optical unit further has first (12), second (13) and third (14) control terminals, wherein the photodiode (2) and the programmable resistive element (4) are coupled in series between the first (12) and third (14) control terminals and M wherein the light emitting diode (3) and the programmable resistive element (4) are coupled between the second (13) and third (14) control terminals. One electrode (2a/2c) of the light-emitting diode, one electrode (3a) of the photodiode and a terminal (4a) of the programmable resistive memory element are connected in common at a node (5). After resetting the programmable resistive memory element to a conducting state/non-conducting state by the application of a reset voltage of a first polarity to the first terminal (12), a programming voltage of opposite polarity to the reset voltage is applied to said first control terminal (12). The degree to which the programmable resistive memory element then changes to a non-conductive state/conductive state in response to the programming voltage is dependent upon the intensity of radiation which is also received by the photodiode (2). In addition there is provided an electro-optical device comprising a plurality of electro-optical units (1) having their first (12), second (13) and third (14) control terminals coupled to respective first, second and third common control lines.

### BACKGROUND OF THE INVENTION

1. Field of the Invention

The present invention relates to an electro-optical unit.

The present invention further relates to an electro-optical device.

The present invention still further relates to a method for operating an electro-optical device.

2. Related Art

Digital information display devices typically comprise a matrix comprising display elements and a row and column addressing mechanism. A particular display element can be addressed by activating its corresponding column and row. Matrix displays may use passive or active addressing. In the latter case one or more transistors or other switching elements are provided for each pixel. Passive addressing is possible for relatively small displays. Larger displays, having a relatively large number of pixels, due to a high resolution an/or a large physical size require active addressing. This requires a large number of components which renders the display expensive and difficult to manufacture.

It is noted that US2003/0201956 discloses a display, comprising a plurality of display cells. At least one of the display cells comprises a light sensor, such as a photo-diode, a display element (e.g. a LED) coupled to the light sensor; and a memory coupled to the light sensor. In an embodiment the memory comprises an energy storage element and a switch selector. A switch may be provided as a field effect transistor (FET) having a gate, a source, and a drain, wherein the gate is the switch selector, the drain is the switch input; and the source is the switch output. In another embodiment the memory is a state machine. The display is optically addressable. This has the advantage of not requiring the control signals for each addressable display cell to be wired into the display. Optically addressable displays can be easily scaled to large sizes and/or high resolutions while requiring less components per pixel.

It is further noted that US2010/00134472 discloses a method and system for multiple-bit programmable resistive cells having a multiple-bit programmable resistive element and using diode as program selector. Programming multiple-bit programmable resistive elements can start by applying a program pulse with initial program voltage (or current) and duration. A read verification cycle can follow to determine if the desirable resistance level is reached. If the desired resistance level has not been reached, additional program pulses can be applied.

### SUMMARY OF THE INVENTION

It is an object of the invention to provide a device capable of displaying information that has a simplified internal structure.

It is a further object of the invention to provide an electro-optical unit for use in such a device.

It is a still further object of the present invention to provide a method for operating the device.

According to a first aspect of the invention an electro-optical unit is provided comprising a photodiode, a light-emitting diode, each having a first and a second electrode and a programmable resistive memory element having a first and a second terminal, the electro-optical unit further having a first, a second and a third control terminal wherein the photodiode and the programmable resistive memory element are coupled in series between the first control terminal and the third control terminal and wherein the light-emitting diode and the programmable resistive memory element are coupled in series between the second control terminal and the third control terminal. The electro-optical unit includes a common node in which one of said first and second electrode of the photodiode, one of said first and second electrode of the light-emitting diode and one of said first and second terminal of the programmable resistive memory element are commonly connected. The programmable resistive memory element is programmable in a conducting state by application of a first voltage between said first and second terminal of the programmable resistive memory element and is programmable in a non-conducting state by application of a second voltage between said first and second terminal of the programmable resistive memory element.

The electro-optical unit according to the first aspect provides for a picture element that can be programmed by electromagnetic radiation. Moreover the internal structure is simplified in that an additional internal node for providing input to the electro-optical unit is avoided.

In a first embodiment of the electro-optical unit according to the first aspect wherein the photodiode is arranged in the same direction in a path from the first control terminal to the third control terminal as the light-emitting diode is arranged in a path from the second control terminal to the third control terminal. The wording “in the same direction” means that the anode and the cathode of the photo-diode are arranged in the same order in the path from the first control terminal to the third control terminal as the anode and the cathode of the light-emitting diode in the path from the second control terminal to the third control terminal. This embodiment can be used to provide for a “negative” display effect. I.e. an electro-optical unit programmed in the presence of light has a dark appearance in a display mode of operation and an electro-optical unit programmed in the absence of light has a bright appearance in the display mode. The process of programming is described in more detail in the sequel of this description.

Alternatively, in a second embodiment the photodiode is arranged in a path from the first control terminal to the third control terminal opposite to the arrangement of the light-emitting diode in a path from the second control terminal to the third control terminal. This embodiment can be used to provide for a “positive” display effect. I.e. an electro-optical unit programmed in the presence of light has a bright appearance in a display mode of operation and an electro-optical unit programmed in the absence of light has a dark appearance in the display mode.

According to a second aspect of the invention an electro-optical device is provided having a plurality of electro-optical units according to the first or the second embodiment of the electro-optical unit of the first aspect. Therein the electro-optical units having their first control terminal, their second control terminal and their third control terminal respectively coupled to a respective common first control line, second control line and a third control line. In the electro-optical device according to the invention, not only can the electro-optical units be of a modest construction, avoiding expensive and vulnerable control elements in each pixel, but in addition only three external control lines are required. Typically one electro-optical device comprises either electro-optical units of the first embodiment or electro-optical units of the second embodiment. Nevertheless for special applications embodiments of the electro-optical device may comprise electro-optical units of both embodiments.

An embodiment of the electro-optical device according to the second aspect comprises electro-optical units of the same sensitivity. This implies that programming the electro-optical units with radiation of the same type and intensity has substantially the effect on the behavior of the electro-optical units in a display modus.

Another embodiment of the electro-optical device according to the second aspect comprises electro-optical units having a mutually different sensitivity, i.e. they are of mutually different sensitivity types. This can be used for example to enable display of a range of luminance levels by providing electro-optical units having a mutually different threshold for the amount of radiation required to change the state of its programmable resistive memory element. Respective subsets of electro-optical units having a mutually different sensitivity may be clustered close to each other, so that they appear as a single pixel, having a controllable brightness, by irradiating the cluster of units during the programming phase with a higher or lower brightness. Electro-optical units may additionally or alternatively have a mutually different sensitivity for a radiation wavelength. This may be used to render color images provided that the electro-optical units also have corresponding light-emitting diodes capable of rendering electromagnetic radiation in mutually different wavelength ranges. In an embodiment the electro-optical units have a respective color filter element, so that incoming radiation is filtered in the same way as outgoing radiation. In this way a color reproduction is enabled without requiring the use of different photodiodes and light-emitting diodes for the electro-optic units.

Dependent on whether the electro-optical units are according to the first embodiment or the second embodiments different methods of operation can be used to program the electro-optical units, i.e. to store an illumination pattern in the arrangement electro-optical units.

An electro-optical device comprising electro-optical units according to the first embodiment can be programmed by a subsequent reset stage and a programming stage.

In the reset stage a reset voltage is applied between the first control line and the third control line. Therein the reset voltage has a polarity corresponding to a forward-biased state of the photodiodes of the electro-optical units in the electro-optical device. The wording “reset” means here that all electro-optical units of the electro-optical device are brought into the same state. In this case the programmable resistive memory element of each of the electro-optical units is rendered into the conducting state as a result of application of the reset voltage. The same effect is achieved in this embodiment if the reset voltage is applied between the second control line and the third control line wherein the reset voltage has a polarity corresponding to a forward-biased state of the light-emitting diodes of the electro-optical units in the electro-optical device. Also a voltage of the same polarity, and for example of the same magnitude may be applied simultaneously between the first and the third terminal and between the second and the third terminal. In the program stage applied subsequent to the reset stage program voltage is applied between the first control line and the third control line. In this stage preferably a voltage is applied simultaneously between the second and the third terminal or the voltage at the second terminal is maintained at ground level, i.e. at the same level as that of the third terminal. The program voltage has a polarity opposite to that of the reset voltage. Also a radiation pattern is applied to the plurality of electro-optical units. The application of the program voltage and the application of the radiation pattern should at least partly overlap in time to achieve a change of state of memory units. The programming stage may extend for a certain time period a number of programming stages may be applied. According to a first example the electro-optical device is a writing pad or electronic board that can be written with a light-pen. When the light-pen is moved over the surface of the electro-optical device, the illuminated electro-optical units change from the common reset state to the programmed state. Multiple programming stages may be used for so called multiple exposure, to encrypt images or for special effects like drawing with a light pen.

An electro-optical device comprising electro-optical units according to the second embodiment can be programmed by the following subsequent reset stage and a programming stage. First a reset voltage is applied between the first control line and the third control line wherein the reset voltage has a polarity corresponding to a forward-biased state of the photodiode. Optionally, a voltage of the same polarity and of the same order of magnitude may be applied between the second and the third control line. Also in this embodiments all electro-optical units of the electro-optical device are set to the same state, i.e. all the programmable resistive memory element assume a non-conducting state. In the subsequent program stage a program voltage is applied between the first control line and the third control line. Therein the program voltage has a polarity opposite to that of the reset voltage and a radiation pattern is applied to the plurality of electro-optical units. In this stage preferably a voltage is applied simultaneously between the second and the third terminal or the voltage at the second terminal is maintained at ground level, i.e. at the same level as that of the third terminal. The application of the program voltage and the application of the radiation pattern at least partly overlap in time.

The radiation-pattern stored in the programmable resistive memory elements can be reproduced in a positive or a negative sense, depending on the embodiment used by applying a display voltage between the second control line and the third control line. Therein the display voltage has polarity corresponding to a forward-biased state of the light-emitting diode and a magnitude smaller than that of the reset voltage and of the program voltage. During the display phase the voltage over the memory element should be lower than its programming voltage. The highest voltage drop occurs over the memory elements programmed in off-state. The display voltage should be lower than the programming voltage. However the voltage drop over the light-emitting diode must be sufficiently high to activate the light-emitting diode. This can best be achieved by a suitable selection of the area Ale of the light-emitting diode and the thickness Dle of its light-emitting layer Dle, as well as the area Amem of the programmable memory and the thickness Dmem of its active layer. Preferably the quantity (Ale/Amem)(Dmem/Dle) is in a range of 0.1 to 0.5. Most preferably, this quantity is in a range of 0.2 to 0.35.

### BRIEF DESCRIPTION OF THE DRAWINGS

These and other aspects are described in more detail with reference to the drawing. Therein:

FIGS. 1A, 1B and 1C respectively show a first, a second and a third embodiment of an electro-optical unit according to the first aspect of the present invention,

FIG. 2 schematically shows an embodiments of an electro-optical device according to the second aspect of the present invention,

FIGS. 3A, 3B and 3C show other embodiments of an electro-optical device according to the second aspect of the present invention,

FIG. 4A schematically shows a practical implementation of a plurality of electro-optical units in an electro-optical device according to the second aspect of the present invention,

FIG. 4B shows a cross-section according to B-B in FIG. 4A,

FIGS. 5A, 5B, 5C and 5D illustrate a method according to the third aspect for operating the electro-optical device according to a first embodiment, Therein FIG. 5A shows voltages applied to control lines of the electro-optical device as a function of time, FIG. 5B, 5C, 5D respectively show a reset stage, a program stage and a display stage of the method,

FIGS. 6A, 6B, 6C and 6D illustrate a method according to the third aspect for operating the electro-optical device according to a second embodiment, Therein FIG. 6A shows voltages applied to control lines of the electro-optical device as a function of time, FIG. 6B, 6C, 6D respectively show a reset stage, a program stage and a display stage of the method,

FIG. 7A and FIG. 7C, 7D show various measurement results obtained with a module as shown in FIG. 7B,

FIG. 8 shows measurements results obtained with an electro-optical unit according to the present invention,

FIGS. 9A and 9B show a further embodiment of an electro-optical device, and FIG. 9C shows a possible application.

### DETAILED DESCRIPTION OF EMBODIMENTS

Like reference symbols in the various drawings indicate like elements unless otherwise indicated.

Unless otherwise defined, all terms (including technical and scientific terms) used herein have the same meaning as commonly understood by one of ordinary skill in the art to which this invention belongs as read in the context of the description and drawings. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In some instances, detailed descriptions of well-known devices and methods may be omitted so as not to obscure the description of the present systems and methods. Terminology used for describing particular embodiments is not intended to be limiting of the invention. As used herein, the singular forms “a”, “an” and “the” are intended to include the plural forms as well, unless the context clearly indicates otherwise. The term “and/or” includes any and all combinations of one or more of the associated listed items. It will be further understood that the terms “comprises” and/or “comprising” specify the presence of stated features but do not preclude the presence or addition of one or more other features. All publications, patent applications, patents, and other references mentioned herein are incorporated by reference in their entirety. In case of conflict, the present specification, including definitions, will control.

As used herein, the term “substrate” has its usual meaning in materials science as an object comprising a surface on which processing is conducted, in this case layer deposition. In a typical semi-conductor manufacturing process, the substrate may be a silicon wafer. In the production of flexible electronics, the substrate typically comprises a foil. The term “foil” refers to a sheet comprising one or more layers of material. Preferably, the foil is flexible such that it can be used in a roll-to-roll (R2R) or roll to sheet (R2S) manufacturing process. For such purpose, a foil may be considered flexible if it can be rolled or bent over a radius of curvature of 50 cm or less, e.g. 12 cm, without losing its essential functionality, e.g. an electronic functionality. Alternatively, or in conjunction a foil may be considered flexible if it has a flexural rigidity smaller than 500 Pa·m̂³.

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. The description of the exemplary embodiments is intended to be read in connection with the accompanying drawings, which are to be considered part of the entire written description. In the drawings, the size and relative sizes of systems, components, layers, and regions may be exaggerated for clarity. Embodiments are described with reference to cross-section illustrations that are schematic illustrations of possibly idealized embodiments and intermediate structures of the invention.

In the description, relative terms as well as derivatives thereof should be construed to refer to the orientation as then described or as shown in the drawing under discussion. These relative terms are for convenience of description and do not require that the system be constructed or operated in a particular orientation unless stated otherwise. It will further be understood that when an element or layer is referred to as being “on” or “coupled to” another element or layer, it can be directly on, or coupled to the other element or layer or intervening elements or layers may be present. In contrast, when an element is referred to as being “directly on,” “connected to” or “directly coupled to” another element or layer, there are no intervening elements or layers present. It will further be understood that when a particular step of a method is referred to as subsequent to another step, it can directly follow said other step or one or more intermediate steps may be carried out before carrying out the particular step.

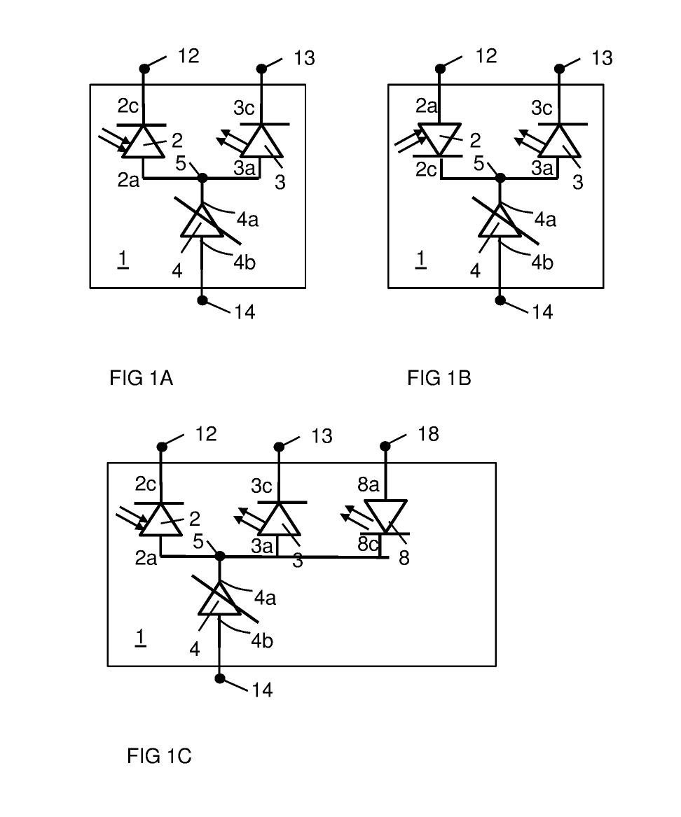

FIG. 1A shows an electro-optical unit 1 comprising a photodiode 2, a light-emitting diode 3 and a programmable resistive memory element 4. The photodiode 2 has a cathode 2c, forming a first electrode and an anode 2a forming a second electrode. Similarly the light-emitting diode 3 has a cathode 3c forming a first electrode and an anode 3a, forming a second electrode. The photodiode 2 and the programmable resistive memory element 4, with terminals 4a, 4b are mutually coupled in series between the first control terminal 12 and the third control terminal 14. Also the light-emitting diode 3 and the programmable resistive memory element 4 are mutually coupled in series between the second control terminal 13 and the third control terminal 14. In a path from the first control terminal 12 to the third control terminal 14 the photodiode 2 is arranged in the same direction as the light-emitting diode in a path from the second control terminal 13 to the third control terminal 14. The anode 2a of the photodiode 2, the anode 3a of the light-emitting diode 3 and terminal 4a of the programmable resistive memory element 4 are commonly connected in node 5.

FIG. 1B shows an alternative embodiment that differs from the embodiment of FIG. 1A in that in a path from the first control terminal 12 to the third control terminal 14 the photodiode 2 is arranged opposite to the light-emitting diode in a path from the second control terminal 13 to the third control terminal 14.

FIG. 1C shows another alternative embodiment that differs from the embodiment of FIG. 1A in that the electro-optical unit has an additional light-emitting diode 8 having its cathode 8 c connected to node 5 and having its anode 8 a coupled to a fourth control terminal 18. In a path from the first control terminal 12 to the third control terminal 14 the photodiode 2 is arranged opposite to the light-emitting diode 8 in a path from the fourth control terminal 18 to the third control terminal 14.

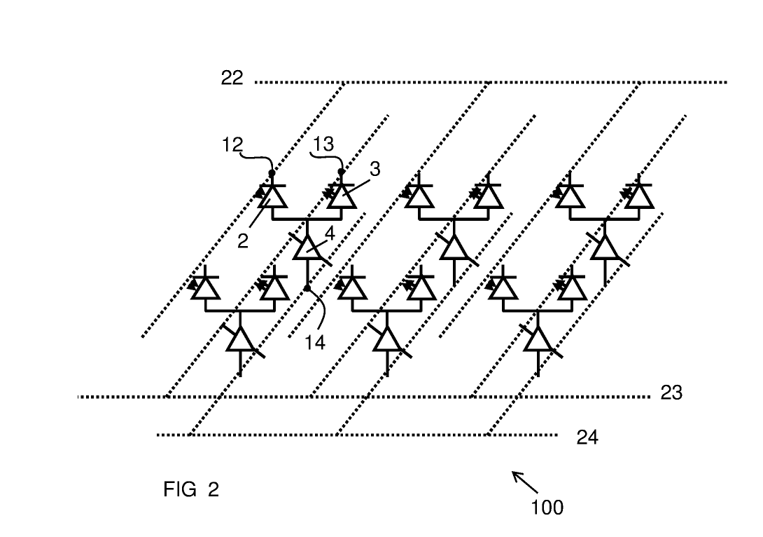

FIG. 2 schematically shows an embodiment of an electro-optical device 100 according to the second aspect of the present invention. The electro-optical device shown therein comprises a plurality of electro-optical units as shown in FIG. 1A, that have their first control terminal 12, their second control terminal 13 and their third control terminal 14 respectively coupled to a respective common first control line 22, second control line 23 and a third control line 24. It may be considered to combine several electro-optic devices in an electro-optical system, wherein each electro-optic device has its own set of control lines. Instead of the electro-optical units according to FIG. 1A, the electro-optical device may comprise electro-optical units according to FIG. 1B, or even electro-optical units of both types. Alternatively an electro-optical system may comprise one or more electro-optical devices with electro-optical units of the type shown in FIG. 1A and one or more electro-optical devices with electro-optical units of the type shown in FIGS. 1B and/or 1C. In the embodiment shown in FIG. 2, the electro-optical units are arranged in a rectangular grid. Other configurations may be used however, such as a hexagonal or a random grid.

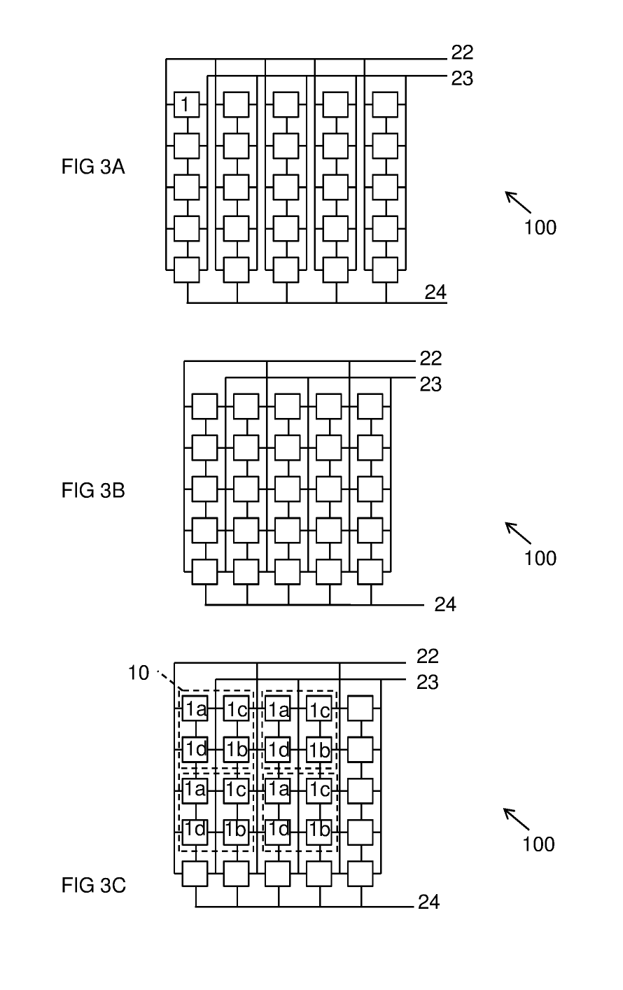

FIG. 3A again shows an electro-optical device 100 having a plurality of electro-optical units 1. The electro-optical units having their first control terminal 12, their second control terminal 13 and their third control terminal 14, as shown in FIG. 1A, 1B, 2 respectively coupled to a respective common first control line 22, second control line 23 and third control line 24. In the embodiment shown the units 1 all have their first terminal 12 on the left-hand side and their second terminal 13 on the right-hand side.

FIG. 3B shows an alternative embodiment of the electro-optical device 100, wherein columns of cells having their first control terminal 12 on the left-hand side and their second control terminal 13 on the right-hand side are alternated by columns of cells having their first control terminal 12 on the right-hand side and their second control terminal 13 on the left-hand side. In this case the number of vertical conductors can be reduced.

FIG. 3C shows again an alternative embodiment of the electro-optical device 100. Therein the electro-optical device comprises electro-optical units of mutually different sensitivity types. In this example the electro-optical device comprises 4 types of units 1a, 1b, 1c, 1d, that have a sensitivity of 1, 2, 3 and 4 light-intensity units. In this way it is possible to reproduce grey tones 0, 1, 2, 3 and 4. It will be clear that the number of different types is not limited to 4, but can be any number. The electro-optical units of mutually different sensitivity types 1a, 1b, 1c, 1d are grouped in clusters 10. In this embodiment the electro-optical units are of mutually different sensitivity type in that they have a mutually different sensitivity for a light-intensity. Alternatively, electro-optical units may be used that differ from each other in that they have photo-diodes with a mutually different color sensitivity. Typically the light-emitting elements in each electro-optical unit render light with a color that corresponds to the color sensitivity of the photo-diode.

Alternatively it is possible to provide the electro-optical device with a color mask having color-filter elements of mutually different filter elements that are arranged in from of the electro-optical units 1. In that case incoming radiation is filtered by the same filter element as outgoing radiation.

It is not necessary that a light-emitting element of an electro-optical unit is configured to emit radiation in a wavelength range corresponding to the wavelength range for which its photodiode is sensitive. In an embodiment the electro-optical units of the electro-optical device according to the present invention are provided with photodiodes sensitive for X-ray radiation and with light-emitting elements configured for emitting radiation in the visible range.

This embodiment is suitable for inspection of metal parts. Therein the electro-optical device is placed against one side of the metal part and an X-ray source is place on the opposite side. Any defects in the metal part become visible by diffusion of the X-ray radiation and therewith as a visible pattern in the image provided by the electro-optical device.

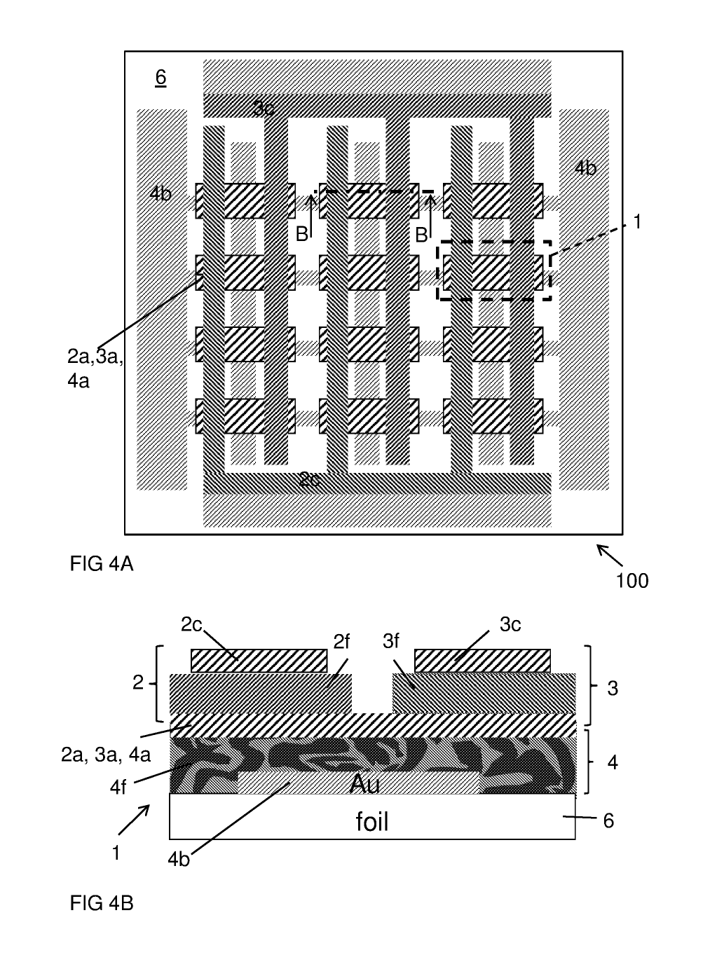

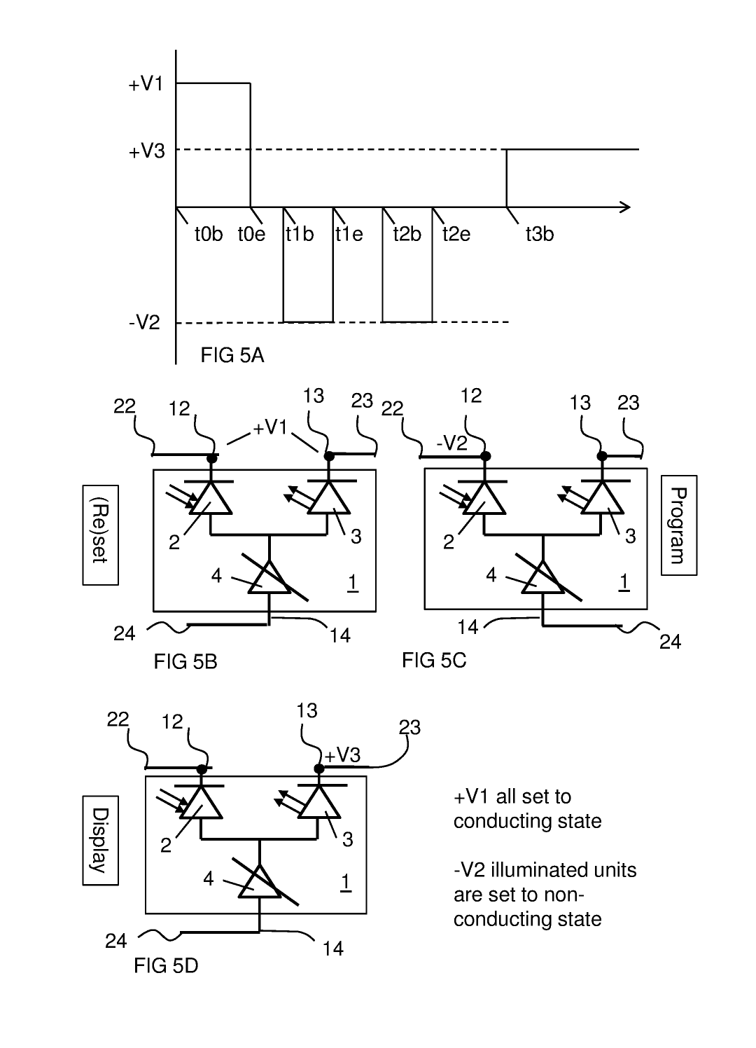

FIG. 4A shows a top-view of an electro-optical device having a plurality of such electro-optical units 1 of which one is specifically indicated by a dashed box. FIG. 4B indicates a cross-section through another one of the electro-optical units. The units 1 are provided on a substrate 6, preferably a flexible foil. The flexible foil is for example of a polymer, e.g. PET or PEN having a thickness in the range of 10-1000 micron, for example in the range of 25-500 micron, for example 125 micron.

A first metal layer 4b, for example of Au, Ag, ITO, Mo, MoOx, forms a first electrode of programmable resistive memory element 4. The programmable resistive memory element 4 further includes a functional layer 4f (for clarity not shown in FIG. 4A), which may be composed as a stack of sub-layers. In the embodiment shown the layer 4f is formed as phase separated VDF-TrFE: OSC blend, wherein OSC may be one of F8BT, PFO, PTAA, PCBM, P3HT for example. A next metal layer, for example of Ag forms a second electrode 4a of the programmable resistive memory element 4. The next metal layer also serves as an anode 2a for the photovoltaic diode 2 and as an anode 3a for the light-emitting element 3. This metal layer may be composed of a stack of sub-layers. The photovoltaic diode 2 further includes a functional layer 2f (for clarity not shown in FIG. 4A), which may be composed as a stack of sub-layers or a blend of more than one material and a cathode 2c, e.g. from Ag. In particular the functional layer 2f is provided in the form of an evaporated stack for example comprising C₆₀/SubPc. The functional layer 2f may also be provided in the form of a blend of a p-type and n-type organic material that are co-deposited and phase separate during drying for example comprising P3HT/PCBM. Likewise, the light-emitting element 3 further includes a functional layer 3f (also for clarity not shown in FIG. 4A), which may be composed as a stack of sub-layers or a blend of more than one material and a cathode 3c, e.g. from Ag. Also functional layer 3 f preferably is provided as an evaporated, using materials known as such to be suitable in organic light-emitting diodes.

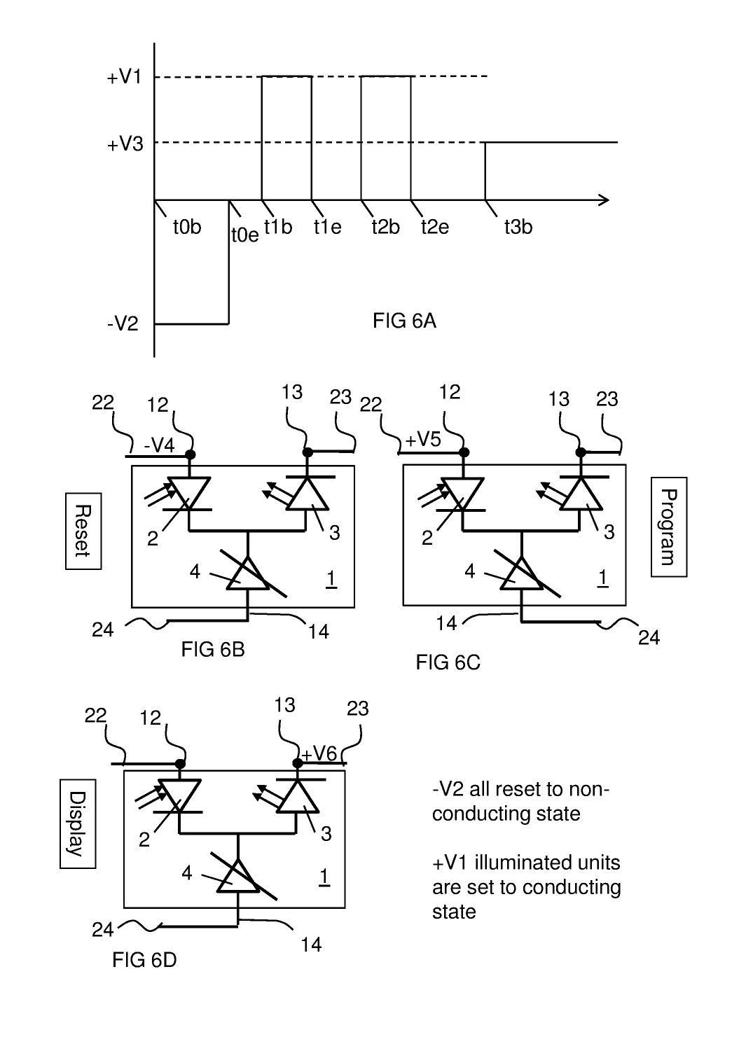

FIG. 5A-5D schematically show a method for operating an electro-optical device with electro-optical units 1 according to FIG. 1A. Therein FIG. 5A shows a value of voltages applied to the control terminals of the electro-optical unit 1 as a function of time. FIGS. 5B-D further illustrate steps of the method for a single unit in the electro-optical device FIG. 5B shows a first step of the method, FIG. 5C shows a second step of the method and FIG. 5D shows a third step of the method. In the first step of the method a reset voltage V1 is applied between the first control terminal 12 and the third control terminal 14. The reset voltage V1 has a polarity corresponding to a conducting state of the photodiode 2. As the photodiode is in its conducting state, a substantial part of the first voltage V1 occurs as a voltage drop Vres over the programmable resistive memory element 4. This voltage drop Vres causes the programmable resistive memory element of each of the electro-optic units 1 to assume a conducting state. Alternatively or simultaneously a reset voltage V1 having a polarity corresponding to the conducting state of the light-emitting diode 3 may be applied between the second control terminal 13 and the third control terminal 14 to cause the programmable resistive memory element to assume its conducting state.

In a subsequent step, shown in FIG. 5C a program voltage V2 is applied between the first control terminal 12 and the third control terminal 14. The program voltage V2 has a polarity opposite to that of the first voltage. In this state the conductivity of the photocliode 2 strongly depends on an intensity of radiation received by the photodiode 2. Accordingly, in this state the voltage drop Vpr over the programmable resistive memory element 4 has a polarity opposite to that in the first state and a magnitude that is relatively high if the photovoltaic diode receives a relatively high intensity of radiation. This has the effect that the conductivity state of the programmable resistive memory element 4 is changed from a conductive state to a non-conductive state. If the photovoltaic diode 2 receives a relatively low intensity of radiation the voltage drop over the programmable resistive memory element 4 is relatively low and the programmable resistive memory element 4 remains in its conductive state. FIG. 5D shows a third step. Therein a display voltage V3 is applied between the second control terminal 13 and the third control terminal 14. The display voltage V3 has polarity corresponding to that of the reset voltage V1 and has a magnitude smaller than that of the reset voltage V1 and of the program voltage V2. In this mode of operation the light emission of the light-emitting element depends on the conductivity state of the programmable resistive memory element 4.

As schematically shown in FIG. 5A, the electro-optic device may be programmed more than once. In this way multiple images can be superposed onto each other for encryption purposes or to obtain special effects. In this example the electro-optical device is reset by applying a reset voltage V1 of about 20 to 25 V, for example 22 V. The reset voltage is applied during a time interval t0b to t0e, for example corresponding to a duration of 1 microsecond to 1 second dependent on the exact value of the reset voltage. Subsequently a first programming step is applied by supplying the programming voltage −V2 in the range of −25 to −20 V for example during the time interval t1b-t1e, corresponding to a duration of 1 microsecond to 1 second dependent on the exact value of the programming voltage in the first programming step. A first illumination or irradiation pattern is applied during at least a portion of this time interval t1b-t1e. The illumination or irradiation pattern may be applied also outside this time interval, but in the absence of a programming voltage no effect is achieved therewith. Subsequently a second programming step is applied by supplying the programming voltage −V2 during the time interval t2b-t2e, corresponding to a duration of 1 microsecond to 1 second dependent on the exact value of the programming voltage in the second programming step. A second illumination or irradiation pattern is applied during at least a portion of this time interval t2b-t2e. As a result the effects of the two illumination or irradiation patterns are superposed. In a later stage, at time t3b the programmed image is displayed by applying a display voltage V3, for example in the range of 10 to 15 V, e.g. 12 V.

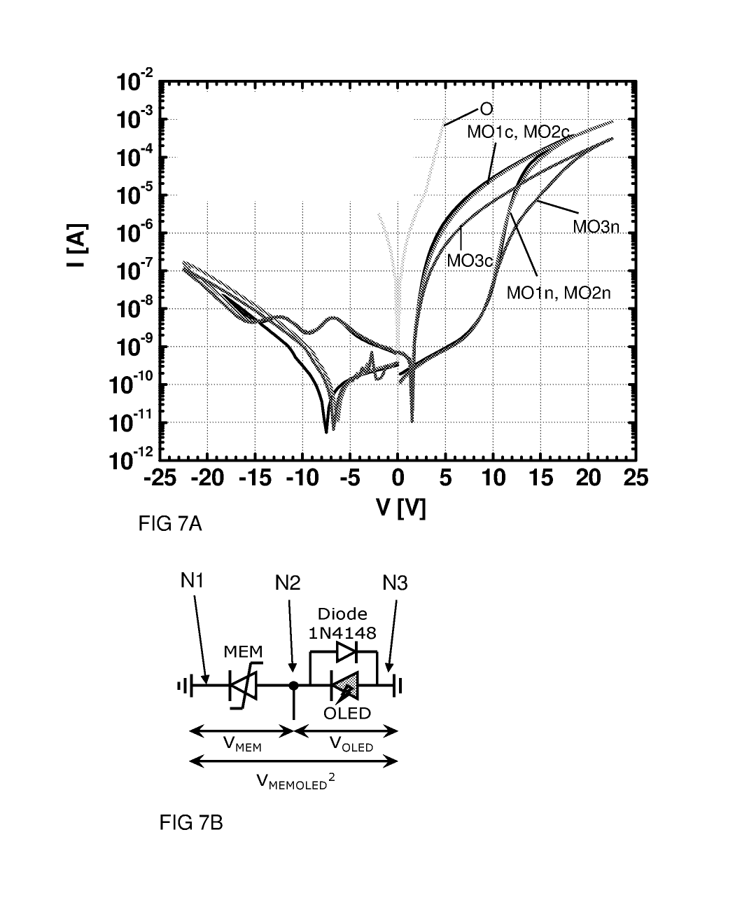

FIG. 6A-6D schematically show a method for operating an electro-optical device with electro-optical units 1 according to FIG. 1B. Therein FIG. 6A shows a value of voltages applied to the control terminals of the electro-optical unit 1 as a function of time. FIGS. 6B-D further illustrate steps of the method for a single unit in the electro-optical device FIG. 6B shows a first step of the method wherein a reset voltage V4 is applied between the first control line 22 and the third control line 24, FIG. 6C shows a second step of the method wherein a program voltage V5 is applied between the first control line 22 and the third control line 24 and FIG. 6D shows a third step of the method wherein a display voltage is applied between the second control line 23 and the third control line 24. The method illustrated in FIG. 6A-6D differs from the method of FIG. 5A-5D in that in this case the polarity of the display voltage V6 corresponds to the polarity of the program voltage V5, whereas in the case shown in FIG. 5A-5D the polarity of the display voltage V3 corresponds to the polarity of the reset voltage V1.

In both the case shown in FIG. 5A-D and in FIG. 6A-D an additional voltage may be applied between the second control line 23 and the third control line 24 during the programming and the reset phase. For practical purposes this additional voltage is equal to the voltage applied between the first control line 22 and the third control line 24 during the reset phase and is equal to the GND voltage during the programming phase. However this is not strictly necessary.

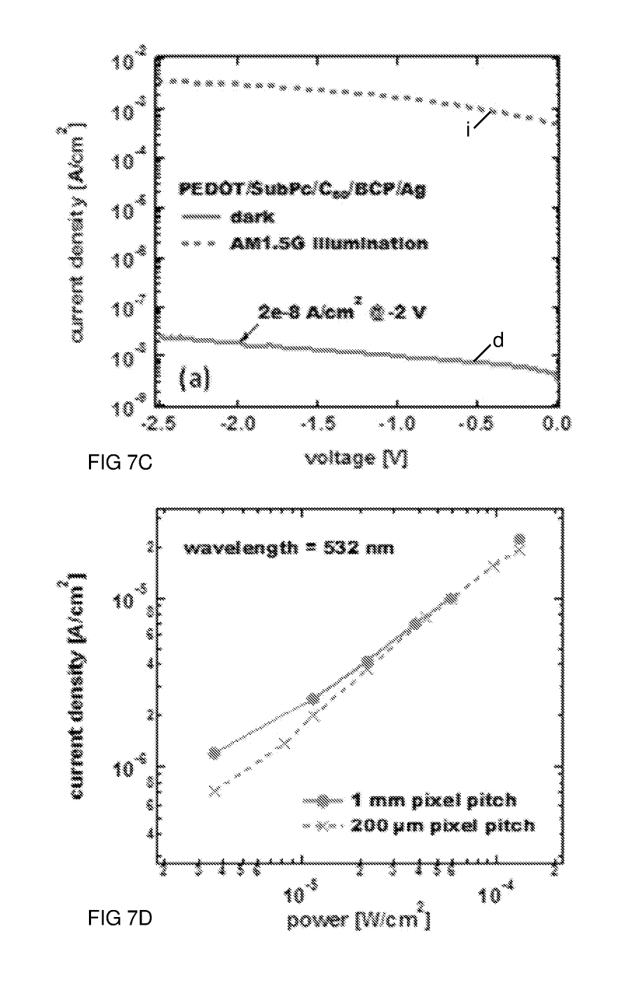

FIG. 7A shows the current I as a function of the applied voltage V between various pairs of nodes of the memory element/OLED tandem as shown in FIG. 7B in accordance with the following table

| Measurement | Nodes | Voltage applied (V) |
|---|---|---|
| O | N2, N3 | −2 < V_{OLED} < +5 |
| MO1 | N1, N2 | −18.5 < V_{MEM} < +18.5 |
| MO2 | N1, N2 | −22.5 < V_{MEM} < +22.5 |
| MO3 | N1, N3 | −22.5 < V_{MEMOLED} < +22.5 |

The measurements MO1, MO2 are applied to the same pair of node, but in a different voltage range. From these measurements it can be observed that the behavior of the memory element is substantially not affected by a change in the voltage range, which could e.g. be the result when it is driven in a series connection with the light emitting element (OLED) in measurement MO3.

The suffix c,n respectively indicate whether the memory element is in the conductive or in the non-conductive mode.

Next, the programmable memory element is programmed by subsequently applying a programming voltage of −19 and +21.5 V between the nodes N1, N3. After programming, the bias was +8 V for 50 seconds during which the OLED is emitting or not, depending on the programmed state. This measurement shows that the programmed state is bistable.

FIGS. 7C and 7D show current voltage characteristics of an organic (evaporated) photodetector, in this case comprising PEDOT/SubPc/C₆₀/BCP/Ag as a stack of layers. FIG. 7C shows the current density in A/cm̂2 as a function of the voltage in V, both for the dark conditions (d) and for conditions (i) wherein the detector is illuminated with (AM 1.5 G illumination). It can be seen that current density measured under illuminated conditions is about 5 orders of magnitude higher than under dark conditions. Under 1.5 AM illumination, the reverse and forward current densities are approximately equal. FIG. 7D shows the current density in A/cm̂2 of diodes with two different areas (1 mm and 200 micron pixel pitch) as a function of incident light intensity in W/cm̂2.

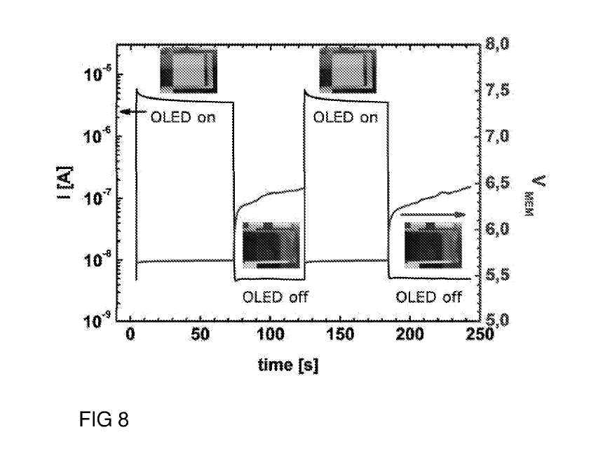

FIG. 8 shows a measurement of the voltage VMEM (V) over the memory element 4 and the current I(A) from the second control terminal 13 to the third control terminal 14 in a unit 1 as shown in FIG. 1 as a function of time. A display voltage of 8 V is applied between these control terminals. At time t is 0 sec the programmable resistive memory element 4 of the electro-optical unit 1 is programmed in its conducting state. In this state the voltage drop over the memory element 4 is about 5.7 V and the remaining voltage over the light-emitting diode 3 is about 2.3 V corresponding to a current of about 5 microampere through the light-emitting element 3 in which the latter is in its illuminated state. After 75 sec the programmable resistive memory element 4 of the electro-optical unit 1 is programmed in its non-conducting state. Subsequent to this programming the voltage drop over the memory element is about 6-6.5 V and the remaining voltage drop over the light-emitting element 3 is in the range of 1.5 to 2 V. Now the current between the second control terminal 13 to the third control terminal 14 is about 5 nanoampere, 3 orders of magnitude lower than in the preceding period of time and the light-emitting element 3 is switched off. The sequence was repeated by again programming the programmable memory element 4 in its conducting state at time 125 seconds and again programming the memory element in its off-state at time 180 sec.

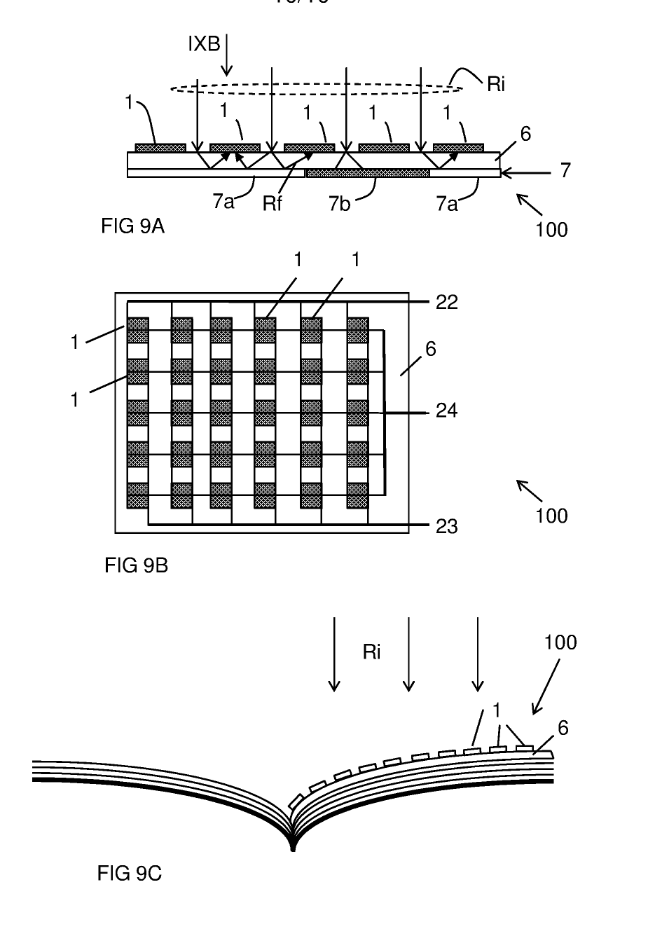

FIGS. 9A and 9B show a further embodiment of an electro-optic device of the present invention. Therein FIG. 9A shows the device in a cross-section and FIG. 9B shows a top-view according to IXB in FIG. 9A. FIG. 9C shows an possible application. The embodiment of the electro-optic device of FIG. 9A, 9B comprises a plurality of electro-optic units 1 distributed with space on a transparent substrate 6. The spaces between the electro-optic units 1 and the transparent substrate 6 allow electro-magnetic radiation Ri, for example visible electro-magnetic radiation, to access a surface 7 (not forming a part of the device) having reflecting and non-reflecting portions 7a, 7b respectively, on which the electro-optic device is arranged. In the programming phase of the opto-electric device each of the electro-optic units 1 is programmed in accordance with the amount of electro-magnetic radiation Rf reflected by the surface. As a result an image of the surface can be reproduced in the display phase of the electro-optic device. Preferably the transparent substrate is of a flexible material, so that the electro-optic device 100 can be applied against a curved surface. This is for example shown in FIG. 9C wherein the electro-optic device is applied against a curved surface of a book. In an other embodiment the substrate 6 is made of a stretchable material and the control lines 22, 23 and 24 connected to the control terminals of the electro-optic units 1 are also stretchable. This may be realized in that they are made of a stretchable electrically conductive material but alternatively or in addition in that they are provided in a meandering pattern. Dependent on the application the stretchable behavior may be elastic, allowing the electro-optic device 100 to resume its original shape once the force used to stretch the device is no longer present. Alternatively the electro-optic device 100 may (partly) maintain its shape obtained by the applied force.

1. Electro-optical unit comprising a photodiode, a light-emitting diode each having a first and a second electrode and a programmable resistive memory element having a first and a second terminal, the electro-optical unit further having a first, a second and a third control terminal wherein the photodiode and the programmable resistive memory element are coupled in series between the first control terminal and the third control terminal and wherein the light-emitting diode and the programmable resistive memory element are coupled in series between the second control terminal and the third control terminal, characterized in that the electro-optical unit includes a common node in which one of said first and second electrode of the photodiode, one of said first and second electrode of the light-emitting diode and one of said first and second terminal of the programmable resistive memory element are commonly connected, and in that the programmable resistive memory element is programmable in a conducting state by application of a first voltage between said first and second control terminal of the electro-optical unit and is programmable in a non-conducting state by application of a second voltage between said first and second control terminal of the electro-optical unit.

2. Electro-optical unit according to claim 1, wherein the photodiode in a path from the first control terminal to the third control terminal is arranged in the same direction as the light-emitting diode in a path from the second control terminal to the third control terminal.

3. Electro-optical unit according to claim 1, wherein the photodiode in a path from the first control terminal to the third control terminal is arranged opposite to the light-emitting diode in a path from the second control terminal to the third control terminal.

4. Electro-optical device having a plurality of electro-optical units as claimed in claim 1, the electro-optical units having their first control terminal, their second control terminal and their third control terminal respectively coupled to a respective common first control line, second control line and a third control line.

5. Electro-optical device having a plurality of electro-optical units as claimed in claim 2, the electro-optical units having their first control terminal, their second control terminal and their third control terminal respectively coupled to a respective common first control line, second control line and third control line.

6. Electro-optical device having a plurality of electro-optical units as claimed in claim 3, the electro-optical units having their first control terminal, their second control terminal and their third control terminal respectively coupled to a respective common first control line, second control line and third control line.

7. Electro-optical device according to claim 4, comprising electro-optical units of mutually different sensitivity types.

8. Method for operating the electro-optical device as specified in claim 5, comprising:
applying a reset voltage between the first control line and the third control line wherein said reset voltage has a polarity corresponding to a forward-biased state of the photodiodes of the electro-optical units in the electro-optical device and/or between the second control line and the third control line wherein said reset voltage has a polarity corresponding to a forward-biased state of the light-emitting diodes of the electro-optical units in the electro-optical device,
subsequently applying a program voltage between the first control line and the third control line, wherein the program voltage has a polarity opposite to that of the reset voltage, and applying a radiation pattern to the plurality of electro-optical units, said applying a program voltage and said applying a radiation pattern being at least partly overlapping in time.

9. Method for operating the electro-optical device as specified in claim 6, comprising:
applying a reset voltage between the first control line and the third control line wherein said reset voltage has a polarity corresponding to a forward-biased state of the photodiode,
subsequently applying a program voltage between the first control line and the third control line, wherein the program voltage has a polarity opposite to that of the reset voltage and applying a radiation pattern to the plurality of electro-optical units, said applying a program voltage and said applying a radiation pattern being at least partly overlapping in time.

10. Method according to claim 8, further comprising:
applying a display voltage between the second control line and the third control line, wherein the display voltage has polarity corresponding to a forward-biased state of the light-emitting diode and a magnitude smaller than that of the reset voltage and of the program voltage.

11. Method according to claim 9, further comprising:
applying a display voltage between the second control line and the third control line, wherein the display voltage has polarity corresponding to a forward-biased state of the light-emitting diode and a magnitude smaller than that of the reset voltage and of the program voltage.
